(19) United States
(12) Patent Application Publication
(10) Pub. No.: US 2025/0277471 A1
(43) Pub. Date: Sep. 4, 2025

(54) FUEL TREATMENT SYSTEM FOR HYBRID GAS-ELECTRIC PROPULSION USING HYDROCARBON FUEL

(71) Applicant: General Electric Company, Schenectady, NY (US)

(72) Inventor: Eyitayo James Owoeye, Houston, TX (US)

(21) Appl. No.: 18/594,384

(22) Filed: Mar. 4, 2024

(51) Int. Cl. F02C 7/224; F02C 6/04

(52) U.S. Cl. CPC F02C 7/224; F02C 6/04; H01M 8/0618; H01M 8/10; F05D 2220/323; F05D 2260/20

(57) ABSTRACT

A fuel treatment system for a hybrid gas-electric propulsion system using a hydrocarbon fuel includes a fuel pre-treatment unit, a recuperator including a first fuel passage and a second fuel passage where the first fuel passage is in fluid communication with a fuel outlet of the fuel pre-treatment unit. A partial oxidation reformer includes a heated fuel inlet and a reformed fuel outlet. The heated fuel inlet is in fluid communication with the fuel pre-treatment unit via the first fuel passage. A solid oxide fuel cell includes an anode inlet and an anode outlet. The anode inlet is in fluid communication with the reformed fuel outlet of the partial oxidation reformer, and the anode outlet is in fluid communication with the second fuel passage of the recuperator. A combustor is in fluid communication with the anode outlet via the second fuel passage.

### FIELD

The present disclosure relates to a hybrid gas-electric propulsion system, and more particularly to a fuel treatment system for a hybrid gas-electric propulsion system using a hydrocarbon fuel.

### BACKGROUND

A hybrid gas-electric propulsion system depends on electrical power that may be generated by processing hydrogen fuel during operation to power a fan section or other components of the propulsion system. Carrying hydrogen fuel onboard an aircraft requires bulky fuel tanks and cooling systems, thus adding weight to the hybrid gas-electric propulsion system.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of an exemplary aircraft that may incorporate at least one exemplary embodiment of the present disclosure.

FIG. 2 is a schematic cross-sectional view of an exemplary turbofan engine as may be incorporated into a propulsion system as shown in FIG. 1, in accordance with an exemplary embodiment of the present disclosure.

FIG. 3 is a schematic diagram of a hybrid gas-electric propulsion system for an aircraft as shown in FIG. 1, or other vehicle, in accordance with an exemplary embodiment of the present disclosure.

FIG. 4 is a schematic diagram of a fuel treatment system for the hybrid gas-electric propulsion system as shown in FIG. 3, according to exemplary embodiments of the present disclosure.

FIG. 5 is a schematic diagram of a portion of the fuel treatment system for the hybrid gas-electric propulsion system as shown in FIG. 4, with the addition of a post-heat heat exchanger, according to an exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise. The term “at least one of” in the context of, e.g., “at least one of A, B, and C” refers to only A, only B, only C, or any combination of A, B, and C.

As used herein, the terms “first”, “second”, and “third” may be used interchangeably to distinguish one component from another and are not intended to signify location or importance of the individual components. Furthermore, the terms “upstream” and “downstream” refer to the relative direction with respect to fluid flow in a fluid pathway. For example, “upstream” refers to the direction from which the fluid flows, and “downstream” refers to the direction to which the fluid flows.

The term “turbomachine” refers to a machine including one or more compressors, a heat generating section (e.g., a combustion section), and one or more turbines that together generate a torque output. The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The terms “coupled,” “fixed,” “attached to,” and the like refer to both direct coupling, fixing, or attaching, as well as indirect coupling, fixing, or attaching through one or more intermediate components or features, unless otherwise specified herein.

The phrases “from X to Y” and “between X and Y” each refers to a range of values inclusive of the endpoints (i.e., refers to a range of values that includes both X and Y).

The terms “fluidly connected” and “fluidly coupled” refer to a fluid connection made between two or more components or systems via pipes, fluid couplings, conduits, valves, and the like, such that a fluid (liquid or gas) may flow therebetween. The term “fluid communication” implies that a fluid (liquid or gas) flows between two or more components or systems. The term “thermal communication” implies that two components, systems, or features are formed, positioned, or configured to transfer thermal energy or heat therebetween.

The present disclosure is generally related to a hybrid-electric propulsion system which uses hydrocarbon fuel. The system disclosed herein provides a near-term solution towards an aviation goal of achieving zero or near-zero emissions via electrification using less bulky fuel tanks compared to Liquid Hydrogen (LH2) fuel-based systems.

Generation of substantial electric power using hydrocarbon fuel is a challenge in hybrid-electric engines due to coke formation in the fuel at the high operating temperature needed by the efficient electric power generation systems. This disclosure introduces a fuel treatment system for processing hydrocarbon fuel in a hybrid-electric aircraft by incorporating solid-oxide fuel cell with a partial oxidation reformer. Solid oxide fuel cells (SOFC) can generate large amounts of power (˜100 MW) due to their high operating temperature (˜800 C) and high efficiency, which makes the suitable for hybrid-electric aircraft engines. Also, SOFC is not vulnerable to carbon-monoxide (CO) poisoning and does not require expensive catalysts due to its high temperature—making it low cost. A partial oxidation reformer is used to convert the hydrocarbon fuel to a hydrogen fuel H2, which is needed by the SOFC. Since the reaction in both units is exothermic, the incorporated system is self-sustaining after cold start-up. The high fuel inlet temperature needed by the SOFC (˜800 C) is supplied by the partial oxidation reformer while the SOFC also acts as a water-gas shift reactor by converting the CO produced by the reformer into CO2 using water produced in the SOFC, which subsequently process more hydrogen fuel to increase electric power generated.

This disclosure introduces a fuel treatment system for a hybrid-electric propulsion using hydrocarbon fuel. The system includes a fuel pre-treatment unit, a recuperation heat exchanger, a partial oxidation reformer, a solid-oxide fuel cell, and a combustion chamber that enable combustion of both hydrocarbon fuel and hydrogen. In exemplary configurations the fuel pre-treatment unit deoxygenates and preheats the hydrocarbon fuel. The fuel pre-treatment unit may include a fuel-air heat exchanger, a fuel deoxygenator or “deoxygenation unit”, and may include, a fuel-oil heat exchanger.

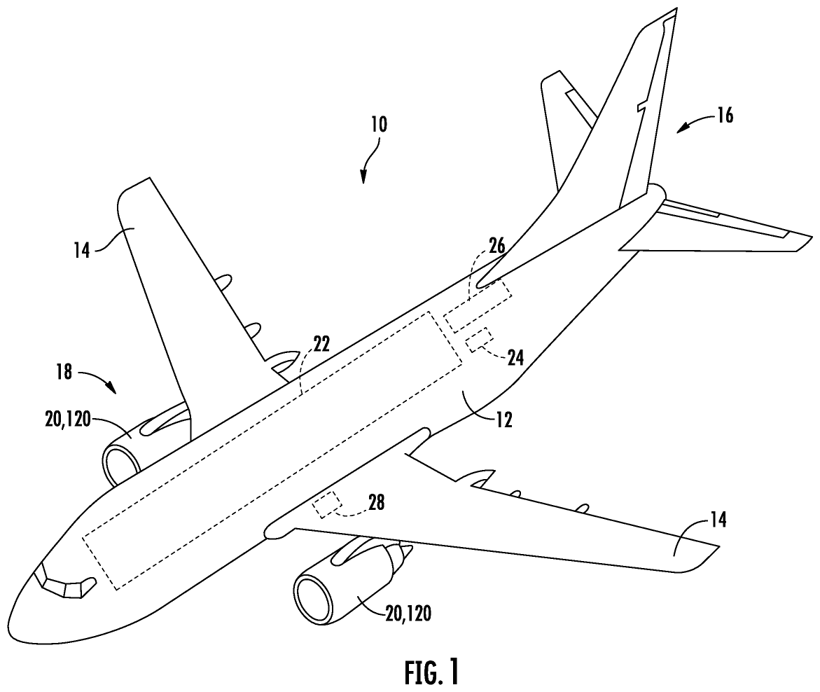

Referring now to the drawings, FIG. 1 is a perspective view of an exemplary aircraft 10 that may incorporate at least one exemplary embodiment of the present disclosure. As shown in FIG. 1, aircraft 10 has a fuselage 12, wing(s) 14 attached to the fuselage 12, and an empennage 16. The aircraft 10 further includes a propulsion system 18 that produces a propulsive thrust to propel the aircraft 10 in flight, during taxiing operations, etc. Although the propulsion system 18 is shown attached to the wing(s) 14, in other embodiments it may additionally or alternatively include one or more aspects coupled to other parts of the aircraft 10, such as, for example, the empennage 16, the fuselage 12, or both. The propulsion system 18 includes at least one gas turbine engine 20 (two gas turbine engines shown). Each gas turbine engine 20 is mounted to aircraft 10 in an under-wing configuration. Each gas turbine engine 20 is capable of selectively generating propulsive thrust for the aircraft 10. Each gas turbine engine 20 may be configured to burn various forms of fuel including, but not limited to unless otherwise provided, jet fuel/aviation turbine fuel, and hydrogen fuel. In addition, or in the alternative, each gas turbine engine 20 may be at least partially operated using onboard generated electric power.

As further show in hidden lines in FIG. 1, the aircraft 10 may include a cabin 22 for carrying passengers or cargo, an environmental control system 24 for supplying air and for controlling temperatures onboard the aircraft 10 and may include an oxygen storage tank 26 for use with the environmental control system or for other uses onboard the aircraft 10. In particular embodiments, the aircraft 10 may include a vent 28 for venting air or exhaust to the atmosphere.

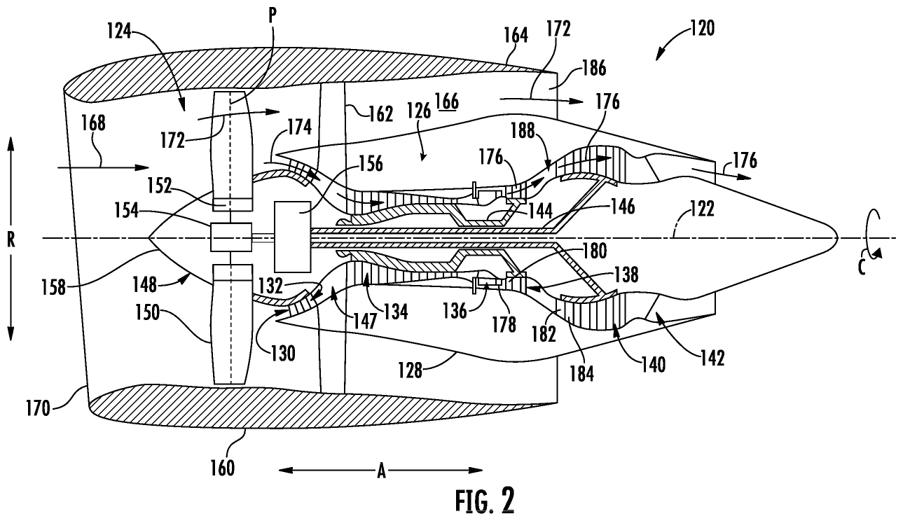

FIG. 2 is a schematic cross-sectional view of a turbofan engine 120 as may be incorporated into the propulsion system 18 shown in FIG. 1, in accordance with an exemplary embodiment of the present disclosure. More particularly. for the embodiment of FIG. 2, the turbofan engine 120 is a high-bypass gas-electric (hybrid) turbofan jet engine. As shown in FIG. 2, the turbofan engine 120 defines an axial direction A (extending parallel to a longitudinal centerline 122 provided for reference) and a radial direction R. In general, the turbofan engine 120 includes a fan section 124 and a core turbine engine 126 disposed downstream from the fan section 124.

The core turbine engine 126 depicted generally includes an outer casing 128 that is substantially tubular and that defines an annular inlet 130. The outer casing 128 encases, in serial flow relationship, a compressor section including a booster or low pressure (LP) compressor or “LP compressor 132” and a high pressure (HP) compressor or “HP compressor 134”, a combustion section 136, a turbine section including a high pressure (HP) turbine or “HP turbine 138” and a low pressure (LP) turbine or “LP turbine 140”, and a jet exhaust nozzle section 142. A high pressure (HP) shaft or spool or “HP shaft or spool 144” drivingly connects the HP turbine 138 to the HP compressor 134. A low pressure (LP) shaft or spool or “LP shaft or spool 146” drivingly connects the IP turbine 140 to the LP compressor 132. The LP compressor 132, HP compressor 134, combustion section 136. HP turbine 138, LP turbine 140, and the jet exhaust nozzle section 142 together define, in serial flow order, a core air flow path through the turbofan engine 120.

For the embodiment depicted, the fan section 124 includes a fan 148 having a plurality of fan blades 150 coupled to a disk 152 in a circumferentially spaced apart manner. As depicted, the fan blades 150 extend outwardly from disk 152 generally along the radial direction R. Each fan blade 150 is rotatable relative to the disk 152 about a pitch axis P by virtue of the fan blades 150 being operatively coupled to a pitch change mechanism 154 configured to collectively vary the pitch of the fan blades 150 in unison. The fan blades 150, disk 152, and pitch change mechanism 154 are together rotatable about the longitudinal centerline 122 by LP shaft or spool 146 across a power gearbox 156. Power gearbox 156 includes a plurality of gears for adjusting the rotational speed of the fan 148 relative to the LP shaft or spool 146 to a more efficient rotational fan speed.

Referring still to the exemplary embodiment of FIG. 2, disk 152 is covered by a front hub 158 that is rotatable and aerodynamically contoured to promote an airflow across and through the plurality of fan blades 150. Additionally, the fan section 124 includes an annular fan casing or nacelle 160 that circumferentially surrounds the fan 148 and/or at least a portion of the core turbine engine 126. The nacelle 160 is supported relative to the core turbine engine 126 by a plurality of circumferentially spaced outlet guide vanes 162. Moreover, a downstream section 164 of the nacelle 160 extends over an outer portion of the core turbine engine 126 to define a bypass airflow passage 166 therebetween.

During operation of the turbofan engine 120, air 168 enters the turbofan engine 120 through an associated inlet 170 of the nacelle 160 and/or fan section 124. As the air 168 passes across the fan blades 150, a first portion 172 of air 168 is directed or routed into the bypass airflow passage 166 and a second portion 174 of air 168 is directed or routed into a core air flowpath 147, or more specifically into the LP compressor 132. The ratio between the first portion 172 of air 168 and the second portion 174 of air 168 is commonly known as a bypass ratio. For the exemplary embodiment depicted, the bypass ratio may be at least about 8:1. Accordingly, the turbofan engine 120 may be referred to as an ultra-high bypass turbofan engine. The pressure of the second portion 174 of air 168 is then increased as it is routed through the HP compressor 134 and into the combustion section 136, where it is mixed with fuel and burned to provide combustion gases 176.

The combustion gases 176 are routed through the HP turbine 138 where a portion of thermal and/or kinetic energy from the combustion gases 176 is extracted via sequential stages of HP turbine stator vanes 178 that are coupled to the outer casing 128 and HP turbine rotor blades 180 that are coupled to the HP shaft or spool 144, thus causing the HP shaft or spool 144 to rotate, which supports operation of the HP compressor 134. The combustion gases 176 are then routed through the LP turbine 140 where a second portion of thermal and kinetic energy is extracted from the combustion gases 176 via sequential stages of LP turbine stator vanes 182 that are coupled to the outer casing 128 and LP turbine rotor blades 184 that are coupled to the LP shaft or spool 146, which causes the LP shaft or spool 146 to rotate, which supports operation of the LP compressor 132 and/or rotation of the fan 148.

The combustion gases 176 are subsequently routed through the jet exhaust nozzle section 142 of the core turbine engine 126 to provide propulsive thrust. Simultaneously, the pressure of the first portion 172 of air 168 is substantially increased as the first portion 172 of air 168 is routed through the bypass airflow passage 166 before it is exhausted from a fan nozzle exhaust section 186 of the turbofan engine 120, also providing propulsive thrust. The HP turbine 138, the LP turbine 140, and the jet exhaust nozzle section 142 at least partially define a hot gas path 188 for routing the combustion gases 176 through the core turbine engine 126.

Turbofan engine 120 depicted in FIG. 2 is configured as an aeronautical gas turbine engine. Aeronautical gas turbine engines, as compared to land-based gas turbine engines, are designed to maximize power output and efficiency while minimizing an overall weight of the gas turbine engine itself, as well as any required accessory systems. It should be appreciated, however, that the turbofan engine 120 depicted in FIG. 2 is provided by way of example only, and that in other exemplary embodiments, the turbofan engine 120 may have any other suitable configuration. It should also be appreciated that in still other exemplary embodiments, aspects of the present disclosure may be incorporated into any other suitable gas turbine engine. For example, in other exemplary embodiments, aspects of the present disclosure may be incorporated into, e.g., a turboprop engine, a turboshaft engine, or a turbojet engine.

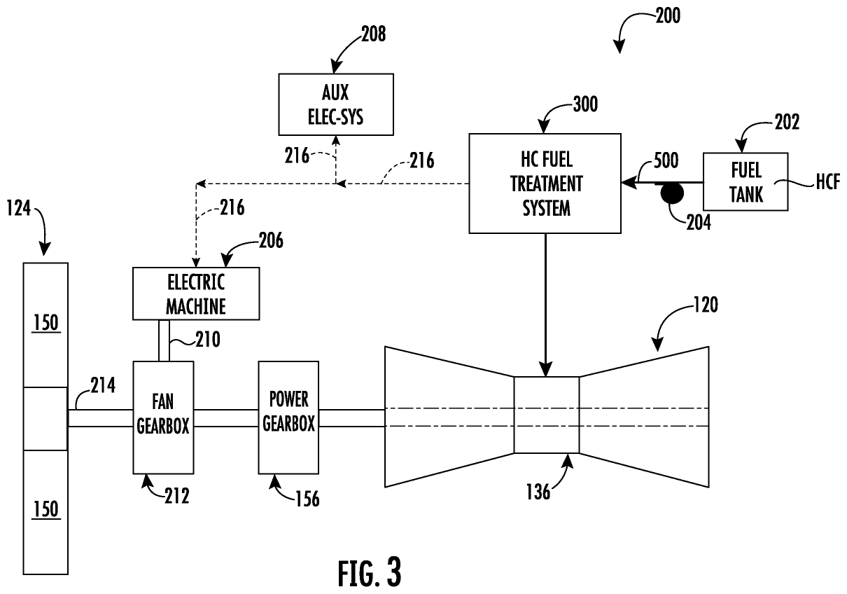

Referring now to FIG. 3, is a schematic diagram of a hybrid gas-electric propulsion system 200 for aircraft 10 shown in FIG. 1, or other vehicle in accordance with an exemplary embodiment of the present disclosure. For the embodiment depicted, the hybrid gas-electric propulsion system 200 includes a fuel tank 202 fluidly coupled to a fuel treatment system 300 for treating a hydrocarbon fuel (500) in the hybrid gas-electric propulsion system 200. Fuel tank 202 is configured to contain and provide hydrocarbon fuel 500 to the fuel treatment system 300. In particular embodiments, a fuel pump 204 provides a motive force for moving the hydrocarbon fuel 500 from the fuel tank 202 to and at least partially through the fuel treatment system 300.

In exemplary embodiments, the fuel treatment system 300 is fluidly coupled to the combustion section 136 of the turbofan engine 120 shown schematically in FIG. 2. As shown in FIG. 3, the fuel treatment system 300 may be electrically connected to an electric machine 206 such as but not limited to an electric motor. In addition, or in the alternative, the fuel treatment system 300 may be electrically connected to an auxiliary electrical system 208 of the aircraft 10 (FIG. 1) such as but not limited to the environmental control system 24 (FIG. 1) or a flight control system (not shown).

In exemplary embodiments, as shown in FIG. 3, electric machine 206 is mechanically coupled via a shaft 210 to a fan gearbox 212. The fan gearbox 212 may be coupled to the fan section 124 of the turbofan engine 120 via a fan shaft 214. In particular configurations, the fan gearbox 212 may be mechanically coupled to the power gearbox 156. In operation, the electric machine 206 receives electrical power 216 from the fuel treatment system 300. converts the electrical power 216 into rotational or mechanical power to turn shaft 210 and to drive the fan gearbox 212, thus driving the fan blades 150 of the fan section 124. In addition, or in the alternative, at least a portion of the electrical power 216 may be sent to the auxiliary electrical system 208 to support various electrical demands of the aircraft 10 (FIG. 1).

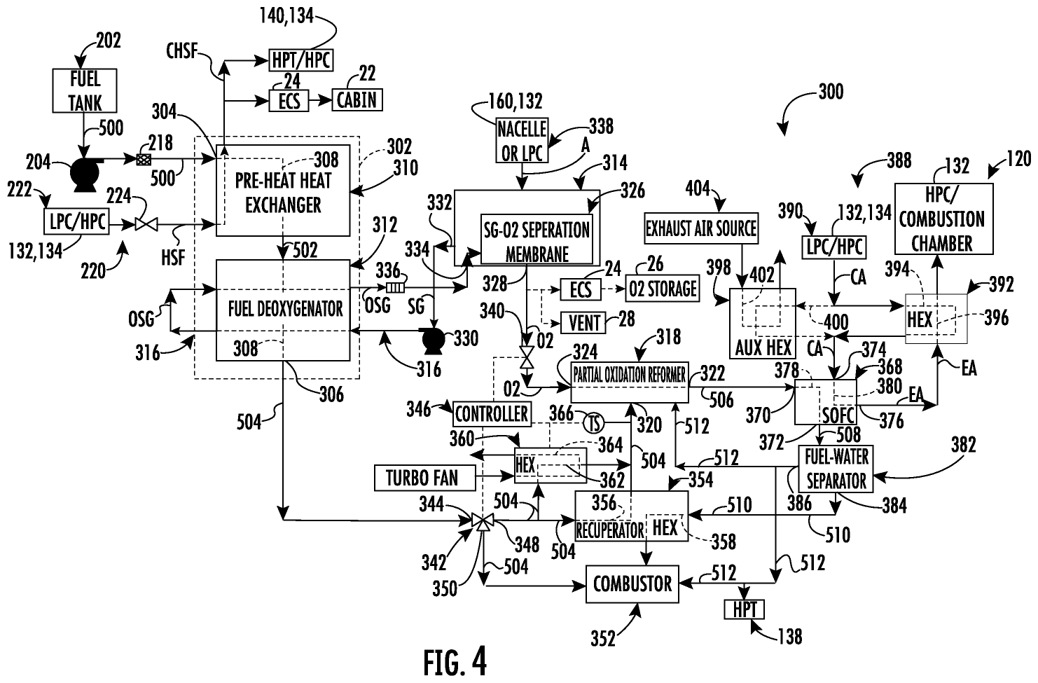

As previously mentioned herein, the fuel treatment system 300 for the hybrid gas-electric propulsion system 200 generally includes a fuel pre-treatment unit fluidly coupled to the fuel tank 202, a sweeping gas generator, a multi-way valve, a recuperator, a partial oxidation reformer, a solid oxide fuel cell, and a combustor, generally arranged as illustrated in the figures and as described herein. FIG. 4 is a schematic diagram of the fuel treatment system 300 for the hybrid gas-electric propulsion system 200 as shown in FIG. 3, according to exemplary embodiments of the present disclosure.

As shown in FIG. 4, the fuel treatment system 300 includes a fuel pre-treatment unit 302. The fuel pre-treatment unit 302 incudes a fuel inlet 304 in fluid communication with fuel tank 202 and a fuel outlet 306. A fuel flow passage 308 (shown in dashed lines) is fluidly coupled to the fuel inlet 304 and the fuel outlet 306 and provides a fluid flow path through the fuel pre-treatment unit 302. The fuel flow passage 308 may be at least partially defined by various pipes, valves, fluid couplings and the like (not shown). As previously provided, the fuel pre-treatment unit 302 is configured to receive the hydrocarbon fuel 500 from the fuel tank 202 via fuel pump 204. The fuel pump 204 provides a motive force to move the hydrocarbon fuel 500 from the fuel tank 202 through the fuel treatment system 300 via various pipes. valves, fluid couplings and the like (not shown). In exemplary embodiments. a fuel filter 218 may be disposed downstream from the fuel pump 204 and upstream from the fuel inlet 304 of the fuel pre-treatment unit 302 to remove particulates from the hydrocarbon fuel 500.

In exemplary embodiments, the fuel pre-treatment unit 302 includes at least one heat exchanger for heating the hydrocarbon fuel 500. In exemplary embodiments, the fuel pre-treatment unit 302 includes a pre-beat heat exchanger 310 in thermal communication with the hydrocarbon fuel 500 via fuel inlet 304, and a fuel deoxygenation unit 312 in fluid and chemical communication with the hydrocarbon fuel 500 via the fuel flow passage 308. The pre-heat heat exchanger 310 and the fuel deoxygenation unit 312 may be formed as a unitary device or body or may be formed from two separate bodies.

In exemplary embodiments, the pre-heat heat exchanger 310 is in thermal communication with a bleed air system 220. The bleed air system 220 may include a hot-side fluid source 222. The hot-side fluid source 222 may include either or both of the LP compressor 132 and the HP compressor 134 which provide a bot-side fluid (HSF), such as compressor bleed air, to the pre-heat heat exchanger 310 via various pipes, valves, fluid couplings and the like (not shown) that extend through the pre-heat heat exchanger 310. A flow valve 224 may be disposed downstream from the hot-side fluid source 222 and upstream from the pre-heat heat exchanger 310. The flow valve 224 may be configured and adjusted to control a flow rate of the hot-side fluid HSF provided to the pre-heat heat exchanger 310 and thus control the amount of heat transfer between the hot-side fluid HSF and the hydrocarbon fuel 500. A downstream end of the bleed air system 220 may be fluidly connected to one or more of the HP turbine 138, the HP compressor 134, the environmental control system 24 for the aircraft 10 (FIG. 1), and the cabin 22 of the aircraft 10 (FIG. 1).

In exemplary embodiments, such as shown in FIG. 3, the fuel treatment system 300 includes a sweeping gas generator 314 for providing a sweeping gas (SG) such as Nitrogen (N2) or other gas suitable for absorbing or sweeping oxygen from the hydrocarbon fuel 500. The sweeping gas generator 314 is fluidly coupled to a sweeping gas circuit 316 formed at least in part by various pipes, valves, fluid couplings, and the like (not shown). The sweeping gas circuit 316 is fluidly coupled to and in fluid and chemical communication with the fuel deoxygenation unit 312 and is fluidly coupled to and in fluid communication with a partial oxidation reformer 318. The partial oxidation reformer 318 includes a heated fuel inlet 320, a reformed fuel outlet 322. and an oxygen inlet 324. In exemplary embodiments, the partial oxidation reformer 318 may be either be a Catalytic Partial Oxidation Reformer (preferred due to lower operation temp. −800 C) or Thermal Partial Oxidation Reformer (with operating temp. of ˜1200 C).

In exemplary embodiments, the sweeping gas generator 314 includes a sweeping gas and oxygen separation membrane, herein referred to as “SG-O2 separation membrane 326”. The sweeping gas generator 314 further includes an exhaust oxygen outlet 328 fluidly coupled to and in fluid communication with the oxygen inlet 324 of the partial oxidation reformer 318. The exhaust oxygen outlet 328 is in fluid communication with the SG-O2 separation membrane 326. The sweeping gas circuit 316 may include a pump 330 fluidly coupled to and in fluid communication with the sweeping gas generator 314 via a sweeping gas outlet 332 of the sweeping gas generator 314 and via a sweeping gas inlet 334 of the sweeping gas generator 314.

The sweeping gas circuit 316 may include a flame arrester 336 disposed downstream from the fuel deoxygenation unit 312 and upstream from the sweeping gas inlet 334. The sweeping gas generator 314 may be fluidly coupled to and in fluid communication with an ambient air source 338 such as, but not limited to. the nacelle 160 or the LP compressor 132. A valve 340 may be fluidly coupled to and in fluid communication with the exhaust oxygen outlet 328 and the oxygen inlet 324 of the partial oxidation reformer 318. In exemplary embodiments, the exhaust oxygen outlet 328 of the sweeping gas generator 314 is fluidly coupled to and in fluid communication with one or more of the environmental control system 24, the oxygen storage tank 26, and the vent 28 of the aircraft 10 (FIG. 1) upstream of the valve 340.

As shown in FIG. 4, a multi-way valve 342 includes an inlet 344 that is fluidly coupled to and in fluid communication with the fuel tank 202 and the fuel flow passage 308 via the fuel outlet 306 of the fuel pre-treatment unit 302. Actuation or manipulation of oxygen flow or fuel flow through either or both valve 340 and the multi-way valve 342 respectively may be controlled by a controller 346. In at least certain exemplary embodiments, the controller 346 may be a full authority digital engine control (“FADEC”) controller. However, in other embodiments, other suitable controllers may be provided. For example, in other embodiments, the controller 346 may include health monitoring units and other electronic systems.

The multi-way valve 342 includes at least a first outlet 348 and a second outlet 350. The second outlet 350 may be fluidly coupled to and in fluid communication with a combustor 352 to enable direct fuel combustion during engine cold start-up. Combustor 352 may be integrated with combustion section 136 of the turbofan engine 120 as shown in FIG. 3 or may be independent thereof. For example. the combustor 352 may be part of a combustion system for an auxiliary power unit (not shown).

In exemplary embodiments, a heat exchanger or “recuperator 354” including a first fuel passage 356 and a second fuel passage 358 is disposed downstream from the first outlet 348 of the multi-way valve 342. More particularly, the first fuel passage 356 is fluidly coupled to and in fluid communication with the fuel pre-treatment unit 302 via the fuel outlet 306 and the first outlet 348 of the multi-way valve 342. In operation, the first fuel passage 356 is in thermal communication with the second fuel passage 358 within the recuperator 354. In exemplary embodiments. the recuperator 354 may be a liquid fuel-to-gas heat exchanger or the like. For example, the first fuel passage 356 may be configured to receive a liquid fuel such as the hydrocarbon fuel 500 while the second fuel passage may be configured to receive a gaseous fuel such as a hydrogen rich fuel.

In an exemplary embodiment, the fuel treatment system 300 includes a cold-start heat exchanger 360. The cold-start heat exchanger 360 may be configured as fuel-to-gas heat exchanger or as an electric heater heat exchanger. The cold-start heat exchanger 360 includes fuel pre-heat passage 362 disposed upstream from the first fuel passage 356 of the recuperator 354, in fluid communication with the fuel outlet 306 of the fuel pre-treatment unit 302, and in fluid communication with the heated fuel inlet 320 of the partial oxidation reformer 318. In particular embodiments, the fuel pre-heat passage 362 may be in fluid communication with the fuel outlet 306 of the fuel pre-treatment unit 302 via the first outlet 348 of the multi-way valve 342.

The cold-start heat exchanger 360 may include an exhaust gas passage 364. In operation, the fuel pre-heat passage 362 is in thermal communication with the exhaust gas passage 364. The exhaust gas passage 364 may be fluidly coupled to and in fluid communication with the turbofan engine 120 (FIG. 3). For example, the exhaust gas passage 364 may be in fluid communication with the LP compressor 132, the HP compressor 134, the combustion section 136, the HP turbine 138, the LP turbine, or the jet exhaust nozzle section 142 of the turbofan engine 120. The cold-start heat exchanger 360, when configured as an electric heater, may include a resistance or other suitable electric powered heater in thermal communication with the fuel pre-heat passage 362.

In exemplary embodiments, the controller 346 is electronically connected to the cold-start heat exchanger 360 and is configured to control or allow fuel flow through the fuel pre-heat passage 362 of the cold-start heat exchanger 360, thus bypassing or at least partially bypassing the first fuel passage 356 of the recuperator 354 in certain operating modes such as during a cold start of the turbofan engine 120.

A temperature sensor 366 may be electronically coupled to the controller 346 and configured to measure and send an electronic signal indicative of fuel temperature as measured upstream from heated fuel inlet 320 of the partial oxidation reformer 318. The controller 346 may be configured to adjust or manipulate either or both valve 340 and multi-way valve 342 from fully closed or zero flow positions, to fully open or full flow positions, or to any open positions defined therebetween, to meter or control a flow volume through the valve 340 or multi-way valve 342 respectively. As such, controller 346 may be configured to regulate the amount of fuel used to generate electric power vs. amount of fuel directly combusted. In addition, or in the alternative, controller 346 may be configured to control flow through the exhaust gas passage 364 or electricity provided to an electric heater of the cold-start heat exchanger 360.

As shown in FIG. 4, a solid oxide fuel cell 368 or “SOFC” is disposed downstream from the reformed fuel outlet 322 of the partial oxidation reformer 318. The solid oxide fuel cell 368 includes an anode inlet 370, an anode outlet 372, a cathode inlet 374, and a cathode outlet 376. An anode flow passage 378 passes through the solid oxide fuel cell 368 and is fluidly coupled to and in fluid communication with the anode inlet 370 and the anode outlet 372. A cathode flow passage 380 passes through the solid oxide fuel cell 368 and is fluidly coupled to and in fluid communication with the cathode inlet 374 and the cathode outlet 376.

The anode inlet 370 is fluidly coupled to and in fluid communication with the reformed fuel outlet 322 of the partial oxidation reformer 318. In exemplary embodiments, the anode outlet 372 may be in fluid communication with the second fuel passage 358 of the recuperator 354. In addition, or in the alternative, the anode outlet 372 may be in fluid communication with the second fuel passage 358 of the recuperator 354. In particular embodiments, the solid oxide fuel cell 368 is configured as a water-gas shift reactor to convert CO into CO2 and generate additional H2 fuel using water produced by the solid oxide fuel cell 368.

In certain embodiments, a fuel and water separation unit 382 is disposed between the solid oxide fuel cell 368 and the recuperator 354 and in fluid communication with the anode outlet 372. The fuel and water separation unit 382 includes a hydrogen fuel outlet 384 and an anode water outlet 386. The hydrogen fuel outlet 384 is fluidly coupled to the second fuel passage 358 of the recuperator 354 and to the combustor 352. In certain embodiments, the anode water outlet 386 may be fluidly coupled to and in fluid communication with one or more of the partial oxidation reformer 318, the HP turbine 138, and the combustor 352.

In particular embodiments, the solid oxide fuel cell 368 may be in thermal communication with a cathode air heating system 388 including a cathode air source 390 and an air-to-air heat exchanger 392 which may be configured as a recuperator. The cathode inlet 374 and the cathode outlet 376 are fluidly coupled to the cathode air heating system 388. The cathode air source 390 may include the LP compressor 132 or the HP compressor 134. The air-to-air heat exchanger 392 includes a cathode air passage 394 fluidly coupled to and in fluid communication with the cathode air source 390 and the cathode inlet 374, and a cathode air exhaust passage 396 fluidly coupled to and in fluid communication with the cathode outlet 376. In operation, cathode air passage 394 is in thermal communication with the cathode air exhaust passage 396. In exemplary embodiments, the cathode air exhaust passage 396 may be fluidly coupled to and in fluid communication with a portion of the turbofan engine 120 (FIG. 3) including but not limited to the HP compressor 134 and combustor 352.

In exemplary embodiments, the cathode air heating system 388 may also include an auxiliary heater 398 such as an air-to-exhaust gas heat exchanger or electric heater. The auxiliary heater 398 is fluidly connected to and in fluid communication with the cathode air source 390 and the cathode inlet 374. The auxiliary heater 398 may be fluidly connected and configured within the cathode air heating system 388 so as to bypass the air-to-air heat exchanger 392 during certain operating modes of the turbofan engine 120 (FIG. 2) such as during a cold-start of the turbofan engine 120 (FIG. 2). The auxiliary heater 398 includes a bypass air passage 400 in fluid communication with the cathode air source 390 and the cathode inlet 374. In embodiments where the auxiliary heater 398 is configured as an air-to-exhaust gas heat exchanger, the auxiliary heater 398 includes an exhaust heat air passage 402 in fluid communication with an exhaust air source 404. The exhaust air source 404 may include the turbofan engine 120 (FIG. 1) such as but not limited to the jet exhaust nozzle section 142 (FIG. 3). In embodiments where the auxiliary heater 398 is configured as an electric heater, the auxiliary heater 398 may include a resistance or other suitable electric powered heater in thermal communication with the bypass air passage 400.

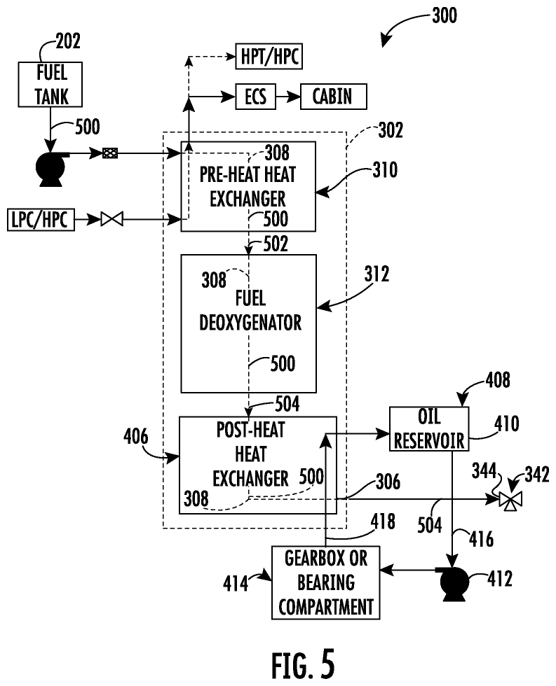

FIG. 5 is a schematic diagram of a portion of the fuel treatment system 300 for the hybrid gas-electric propulsion system 200 as shown in FIG. 4 with the addition of a post-heat heat exchanger 406 added to the fuel pre-treatment unit 302, according to exemplary embodiments of the present disclosure. It is to be appreciated that the fuel treatment system 300 of FIGS. 4 and 5 have like components and use the same reference numbers for the common components. In the exemplary embodiment shown in FIG. 5, the fuel pre-treatment unit 302 is in fluid communication with fuel tank 202 and is configured to receive the hydrocarbon fuel 500 therefrom. The pre-heat heat exchanger 310 is in thermal communication with the hydrocarbon fuel 500 via the fuel flow passage 308. The fuel deoxygenation unit 312 is in fluid and chemical communication with the hydrocarbon fuel 500 downstream from the pre-heat heat exchanger 310.

The post-heat heat exchanger 406 is disposed downstream from the fuel deoxygenation unit 312 and is in thermal communication with the hydrocarbon fuel 500 after it passes through the fuel deoxygenation unit 312. The post-heat heat exchanger 406 is also fluidly connected to and in fluid communication with the inlet 344 of the multi-way valve 342 via the fuel outlet 306 of the fuel pre-treatment unit 302. The pre-heat heat exchanger 310, the fuel deoxygenation unit 312, and the post-heat heat exchanger 406 may be formed or packaged as a unitary device or body. In the alternative, the pre-heat heat exchanger 310, the fuel deoxygenation unit 312, and the post-heat heat exchanger 406 may be formed from two or more separate devices.

The post-heat heat exchanger 406 is also in thermal communication with a hot-side fluid system 408. The hot-side fluid system 408 may include an oil reservoir 410, a pump 412, and a heat source 414 such as a gearbox or bearing compartment. In operation, oil 416 is drawn from the oil reservoir 410 by the pump 412 and passed through the heat source 414 to pick up heat. The now heated oil 418 is routed through the post-heat heat exchanger 406 where at least a portion of the heat picked up by the oil 418 from the heat source 414 is transferred to the flow of the hydrocarbon fuel 500 flowing from the fuel deoxygenation unit 312, thus cooling the heated oil 418 upstream from the oil reservoir 410.

The fuel treatment system 300 as arranged and described herein and as shown in FIGS. 4 and 5 collectively, provides a system for processing the hydrocarbon fuel 500 and converting it into a hydrogen H2 fuel for a hybrid-electric aircraft by incorporating solid-oxide fuel cell with a partial oxidation reformer while addressing or preventing potential coke formation in the hydrocarbon fuel 500 at the high operating temperatures needed by the efficient electric power generation system of a hybrid electric aircraft.

Referring first to FIG. 4, in operation, the hydrocarbon fuel 500 is drawn from the fuel tank 202, passed through the fuel filter 218 (when present) to remove particulates generally present in the hydrocarbon fuel 500, and then passed into the pre-heat heat exchanger 310 of the fuel pre-treatment unit 302. Heat is transferred from the hot-side fluid HSF of the bleed air system 220 to the hydrocarbon fuel 500. The hot-side fluid HSF is cooled thus producing a cooled hot-side fluid (CHSF) which may be routed to one or more of the environmental control system 24 which supply the cabin 22, directly to the cabin 22, the HP turbine 138, and the HP compressor 134. When the CHSF is routed to the environmental control system (ECS) 24, the pre-heat heat exchanger 310 acts as the ECS precooler, eliminating the need for a separate ECS precooler heat exchanger and lowering engine weight. When the CHSF is routed to the HP turbine 138 and/or HP compressor 134, it serves as a cooling air to enable engine operation at higher temperatures, which increases fuel efficiency. Flow valve 224 (when present) may be adjusted to control the flow rate of the hot-side fluid HSF through pre-heat heat exchanger 310 thus controlling the temperature of the hydrocarbon fuel 500 as it passes through the pre-heat heat exchanger 310 and into the fuel deoxygenation unit 312.

As now heated hydrocarbon fuel 502 passes through the fuel deoxygenation unit 312, the sweeping gas SG from the sweeping gas generator 314 flows through the sweeping gas circuit 316 and into the fuel deoxygenation unit 312 where it reacts with the heated hydrocarbon fuel 502 to sweep or absorb oxygen from the heated hydrocarbon fuel 502, thus producing an oxygenated sweeping gas (OSG) and a heated deoxygenated hydrocarbon fuel 504. The oxygenated sweeping gas OSG is routed back to the sweeping gas generator 314 wherein the SG-O2 separation membrane 326 separates the absorbed oxygen from the sweeping gas SG. The sweeping gas SG is allowed to flow back through the sweeping gas circuit 316 for continued operation. In an exemplary embodiment, the sweeping gas is Nitrogen (N2).

In particular embodiments, the SG-O2 separation membrane 326 may separate nitrogen (N2) from oxygen (O2) and other gases from ambient air (A) drawn into the sweeping gas generator 314 from the ambient air source 338. The nitrogen may be used as the sweeping gas SG. This configuration allows for the generation of sweeping gas SG during operation of the aircraft 10 without having to carry a sweeping gas storage system onboard the aircraft 10 or onboard the turbofan engine 120, thus saving weight and additional system components.

Oxygen (O2) separated from the oxygenated sweeping gas OSG or excess oxygen from ambient air A may be routed from the exhaust oxygen outlet 328 to the partial oxidation reformer 318. In addition, or in the alternative, the oxygen O2 may be routed to one or more of the environmental control system 24, the oxygen storage tank 26, and the vent 28 for venting the oxygen O2 to atmosphere.

Referring briefly to FIG. 5, in an exemplary embodiment wherein the post-heat heat exchanger 406 is present in the fuel pre-treatment unit 302 the now heated deoxygenated hydrocarbon fuel 504 may be routed through the post-heat heat exchanger 406 wherein additional heat is transferred from the heated oil 418 of the hot-side fluid system 408 to the heated deoxygenated hydrocarbon fuel 504, thus further raising an operating temperature of the deoxygenated hydrocarbon fuel 500 upstream from the multi-way valve 342.

Referring back to FIG. 4, the controller 346 may send an electronic signal to the multi-way valve 342 to manipulate the multi-way valve 342 so as to control a flow rate of the heated deoxygenated hydrocarbon fuel 504 to one or more of the combustor 352 for combustion, to the recuperator 354 for further processing, and to the cold-start heat exchanger 360 for when the turbofan engine 120 is in a cold-start condition. The temperature sensor 366 may send a signal back to the controller 346 that is indicative of a temperature of the heated deoxygenated hydrocarbon fuel 504 just upstream from heated fuel inlet 320 of the partial oxidation reformer 318.

In exemplary embodiments, if the temperature of the heated deoxygenated hydrocarbon fuel 504 is less than 800 C for when the partial oxidation reformer 318 is a catalytic partial oxidation reformer, or less than 1200 C for when the partial oxidation reformer 318 is a thermal partial oxidation reformer, the controller 346 may send an electronic signal to the cold-start heat exchanger 360 instructing it to open or otherwise receive at least a portion or all of the heated deoxygenated hydrocarbon fuel 504 from the first outlet 348 of the multi-way valve 342 for additional heating to the proper operational temperature of the partial oxidation reformer 318. In a non-cold-start condition, the heated deoxygenated hydrocarbon fuel 504 is routed through the first fuel passage 356 of the recuperator 354 to provide the heated deoxygenated hydrocarbon fuel 504 to the partial oxidation reformer 318 at the appropriate temperature for operation.

As the heated deoxygenated hydrocarbon fuel 504 flows through the partial oxidation reformer 318 it reacts with the oxygen O2 from the exhaust oxygen outlet 328 of the sweeping gas generator 314. The exothermic reaction produces a hydrogen rich+carbon monoxide fuel mixture or “H2+CO fuel mixture 506”. The hot H2+CO fuel mixture 506 is then routed into the anode inlet 370 of the solid oxide fuel cell 368. Within the solid oxide fuel cell, the H2+CO fuel mixture 506 reacts as an anode with cathode air (CA) provided by the cathode air source 390 of the cathode air heating system 388. The cathode air CA reacts as a cathode within the solid oxide fuel cell 368. Excess air (EA) from the exothermic reaction within the solid oxide fuel cell 368 may be routed from the cathode outlet 376, through the air-to-air heat exchanger 392 and on to the one or more other components or systems of the turbofan engine 120 or the aircraft 10 such as but not limited to the HP compressor 134 or a combustion chamber.

In exemplary embodiments, the solid oxide fuel cell 368 acts as a water-gas shift reactor to the reaction in the solid oxide fuel cell 368 between the H2+CO fuel mixture 506 and the cathode air CA, thus converting the CO into CO2 and generating more hydrogen fuel using water produced by the solid oxide fuel cell 368. This results in a hydrogen+carbon dioxide and water fuel mixture or “H2+CO2+H2O fuel mixture 508”. In embodiments, the fuel and water separator 382 may separate the H2+CO2 from the H2O, thus producing a hydrogen and carbon dioxide fuel mixture or “hot H2+CO2 fuel mixture 510” and anode water 512.

Because the reactions in the partial oxidation reformer 318 and the solid oxide fuel cell 368 are both exothermic, the hot H2+CO2 fuel mixture 510 may be routed to the recuperator 354 to preheat the heated deoxygenated hydrocarbon fuel 504, before hot H2+CO2 fuel mixture 510 is then routed into the combustor 352 for combustion. The hot H2+CO2 fuel mixture 510 may be routed to the recuperator 354 for additional heating upstream from the combustor 352 and then routed into the combustor 352 for combustion. The anode water 512 may be routed from the fuel and water separation unit 382 to one or more of the HP turbine 138 for cooling, the combustor for NOx reduction, and the partial oxidation reformer 318 to reduce soot formation therein, thus increasing life expectancy of a catalyst of the partial oxidation reformer 318.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A fuel treatment system for a hybrid gas-electric propulsion system using a hydrocarbon fuel, the fuel treatment system comprising: a fuel pre-treatment unit including a fuel inlet, a fuel outlet, and a fuel flow passage defined therebetween; a recuperator including a first fuel passage and a second fuel passage, wherein the first fuel passage is in fluid communication with the fuel outlet of the fuel pre-treatment unit; a partial oxidation reformer including a heated fuel inlet and a reformed fuel outlet, wherein the heated fuel inlet is in fluid communication with the fuel pre-treatment unit via the first fuel passage; a solid oxide fuel cell including an anode inlet and an anode outlet, wherein the anode inlet is in fluid communication with the reformed fuel outlet of the partial oxidation reformer, and wherein the anode outlet is in fluid communication with the second fuel passage of the recuperator; and a combustor in fluid communication with the anode outlet via the second fuel passage.

The fuel treatment system of the previous or any following clause, wherein the fuel pre-treatment unit includes a pre-heat heat exchanger and a fuel deoxygenation unit, wherein the fuel flow passage passes through the pre-heat heat exchanger and the fuel deoxygenation unit.

The fuel treatment system of any previous or following clause, wherein the fuel pre-treatment unit includes a post-heat heat exchanger disposed downstream from and in fluid communication with the fuel deoxygenation unit via the fuel flow passage.

The fuel treatment system of any previous or following clause, further comprising a sweeping gas generator including a sweeping gas circuit, wherein the fuel pre-treatment unit includes a fuel deoxygenation unit, wherein the sweeping gas circuit is in fluid communication with the fuel deoxygenation unit.

The fuel treatment system of any previous or following clause, wherein the sweeping gas generator includes a sweeping gas and oxygen separation membrane.

The fuel treatment system of any previous or following clause, wherein the partial oxidation reformer includes an oxygen inlet, wherein the sweeping gas generator includes an exhaust oxygen outlet in fluid communication with the sweeping gas and oxygen separation membrane, wherein the exhaust oxygen outlet is in fluid communication with the oxygen inlet of the partial oxidation reformer.

The fuel treatment system of any previous or following clause, wherein the solid oxide fuel cell is configured as a water-gas shift reactor.

The fuel treatment system of any previous or following clause, further comprising a cold-start heat exchanger including a fuel pre-heat passage, wherein the fuel pre-heat passage is in fluid communication with the fuel outlet of the fuel pre-treatment unit and the heated fuel inlet of the partial oxidation reformer.

The fuel treatment system of any previous or following clause, wherein the fuel pre-heat passage is in fluid communication with the fuel outlet of the fuel pre-treatment unit upstream from the first fuel passage of the recuperator.

The fuel treatment system of any previous or following clause, wherein the cold-start heat exchanger includes an exhaust gas passage in fluid communication with a turbofan engine, wherein the fuel pre-heat passage is in thermal communication with the exhaust gas passage.

The fuel treatment system of any previous or following clause, wherein the cold-start heat exchanger includes an electric heater, wherein the fuel pre-heat passage is in thermal communication with the electric heater.

The fuel treatment system of any previous or following clause, further comprising a fuel and water separation unit in fluid communication with the anode outlet, wherein the fuel and water separation unit includes a hydrogen fuel outlet in fluid communication with the combustor via the second fuel passage of the recuperator.

The fuel treatment system of any previous or following clause, wherein the fuel and water separation unit includes an anode water outlet, wherein the anode water outlet is in fluid communication with the partial oxidation reformer.

The fuel treatment system of any previous or following clause, wherein the fuel and water separation unit includes an anode water outlet, wherein the anode water outlet is in fluid communication with the combustor.

The fuel treatment system of any previous or following clause, wherein the fuel and water separation unit includes an anode water outlet, wherein the anode water outlet is in fluid communication with a high pressure turbine of a turbofan engine.

The fuel treatment system of any previous or following clause, further comprising a controller, wherein the controller is configured to regulate one or more of an oxygen flowrate, fuel flowrate, and fuel temperature supplied to the partial oxidation reformer.

The fuel treatment system of any previous or following clause, further comprising a cathode air heating system, wherein the solid oxide fuel cell includes a cathode inlet and a cathode outlet, wherein the cathode inlet and the cathode outlet are fluidly coupled to the cathode air heating system.

The fuel treatment system of any previous or following clause, wherein the cathode air heating system includes a cathode air source and an air-to-air heat exchanger, wherein the air-to-air heat exchanger includes a cathode air passage in fluid communication with the cathode inlet, and a cathode air exhaust passage in fluid communication with the cathode outlet.

The fuel treatment system of any previous or following clause, wherein the cathode air heating system includes a cathode air source and an auxiliary heater, wherein the auxiliary heater includes a bypass air passage in fluid communication with a cathode air source and the cathode inlet, and an exhaust heat air passage in fluid communication with an exhaust air source.

The fuel treatment system of any previous or following clause, wherein the cathode air heating system includes a cathode air source and an auxiliary heater, wherein the auxiliary heater includes a bypass air passage in fluid communication with a cathode air source and the cathode inlet, and an electric heater in thermal communication with the bypass air passage.

We claim:

1. A fuel treatment system for a hybrid gas-electric propulsion system using a hydrocarbon fuel, the fuel treatment system comprising:
a fuel pre-treatment unit including a fuel inlet, a fuel outlet, and a fuel flow passage defined therebetween;
a recuperator including a first fuel passage and a second fuel passage, wherein the first fuel passage is in fluid communication with the fuel outlet of the fuel pre-treatment unit;
a partial oxidation reformer including a heated fuel inlet and a reformed fuel outlet, wherein the heated fuel inlet is in fluid communication with the fuel pre-treatment unit via the first fuel passage;
a solid oxide fuel cell including an anode inlet and an anode outlet, wherein the anode inlet is in fluid communication with the reformed fuel outlet of the partial oxidation reformer, and wherein the anode outlet is in fluid communication with the second fuel passage of the recuperator; and
a combustor in fluid communication with the anode outlet via the second fuel passage.

2. The fuel treatment system of claim 1, wherein the fuel pre-treatment unit includes a pre-heat heat exchanger and a fuel deoxygenation unit, wherein the fuel flow passage passes through the pre-heat heat exchanger and the fuel deoxygenation unit.

3. The fuel treatment system of claim 2, wherein the fuel pre-treatment unit includes a post-heat heat exchanger disposed downstream from and in fluid communication with the fuel deoxygenation unit via the fuel flow passage.

4. The fuel treatment system of claim 1, further comprising a sweeping gas generator including a sweeping gas circuit, wherein the fuel pre-treatment unit includes a fuel deoxygenation unit, wherein the sweeping gas circuit is in fluid communication with the fuel deoxygenation unit.

5. The fuel treatment system of claim 4, wherein the sweeping gas generator includes a sweeping gas and oxygen separation membrane.

6. The fuel treatment system of claim 5, wherein the partial oxidation reformer includes an oxygen inlet, wherein the sweeping gas generator includes an exhaust oxygen outlet in fluid communication with the sweeping gas and oxygen separation membrane, wherein the exhaust oxygen outlet is in fluid communication with the oxygen inlet of the partial oxidation reformer.

7. The fuel treatment system of claim 1, wherein the solid oxide fuel cell is configured as a water-gas shift reactor.

8. The fuel treatment system of claim 1, further comprising a cold-start heat exchanger including a fuel pre-heat passage, wherein the fuel pre-heat passage is in fluid communication with the fuel outlet of the fuel pre-treatment unit and the heated fuel inlet of the partial oxidation reformer.

9. The fuel treatment system of claim 8, wherein the fuel pre-heat passage is in fluid communication with the fuel outlet of the fuel pre-treatment unit upstream from the first fuel passage of the recuperator.

10. The fuel treatment system of claim 8, wherein the cold-start heat exchanger includes an exhaust gas passage in fluid communication with a turbofan engine, wherein the fuel pre-heat passage is in thermal communication with the exhaust gas passage.

11. The fuel treatment system of claim 8, wherein the cold-start heat exchanger includes an electric heater, wherein the fuel pre-heat passage is in thermal communication with the electric heater.

12. The fuel treatment system of claim 1, further comprising a fuel and water separation unit in fluid communication with the anode outlet, wherein the fuel and water separation unit includes a hydrogen fuel outlet in fluid communication with the combustor via the second fuel passage of the recuperator.

13. The fuel treatment system of claim 12, wherein the fuel and water separation unit includes an anode water outlet, wherein the anode water outlet is in fluid communication with the partial oxidation reformer.

14. The fuel treatment system of claim 12, wherein the fuel and water separation unit includes an anode water outlet, wherein the anode water outlet is in fluid communication with the combustor.

15. The fuel treatment system of claim 12, wherein the fuel and water separation unit includes an anode water outlet, wherein the anode water outlet is in fluid communication with a high pressure turbine of a turbofan engine.

16. The fuel treatment system of claim 1, further comprising a controller, wherein the controller is configured to regulate one or more of an oxygen flowrate, fuel flowrate, and fuel temperature supplied to the partial oxidation reformer.

17. The fuel treatment system of claim 1, further comprising a cathode air heating system, wherein the solid oxide fuel cell includes a cathode inlet and a cathode outlet, wherein the cathode inlet and the cathode outlet are fluidly coupled to the cathode air heating system.

18. The fuel treatment system of claim 17, wherein the cathode air heating system includes a cathode air source and an air-to-air heat exchanger, wherein the air-to-air heat exchanger includes a cathode air passage in fluid communication with the cathode inlet, and a cathode air exhaust passage in fluid communication with the cathode outlet.

19. The fuel treatment system of claim 17, wherein the cathode air heating system includes a cathode air source and an auxiliary heater, wherein the auxiliary heater includes a bypass air passage in fluid communication with a cathode air source and the cathode inlet, and an exhaust heat air passage in fluid communication with an exhaust air source.

20. The fuel treatment system of claim 17, wherein the cathode air heating system includes a cathode air source and an auxiliary heater, wherein the auxiliary heater includes a bypass air passage in fluid communication with a cathode air source and the cathode inlet, and an electric heater in thermal communication with the bypass air passage.
